(19) United States
(12) Patent Application Publication
(10) Pub. No.: US 2007/0141446 A1
(43) Pub. Date: Jun. 21, 2007

(54) Fuel cell gas diffusion articles

(75) Inventors: Wai M. Choi, W. Newton, MA (US); John A. Wertz, Hollis, NH (US)

Correspondence Address: FISH & RICHARDSON PC, P.O. BOX 1022, MINNEAPOLIS, MN, 55440-1022, US

(73) Assignee: HOLLINGSWORTH & VOSE COMPANY

(21) Appl. No.: 11/639,376

(22) Filed: Dec. 14, 2006

Related U.S. Application Data
(60) Provisional application No. 60/750,484, filed on Dec. 15, 2005.

(51) Int. Cl. H01M 4/94; H01M 4/88

(52) U.S. Cl. 429/42; 429/44; 502/101

(57) ABSTRACT

Fuel cell gas diffusion articles containing a porous layer, as well as related components, systems, and methods, are disclosed.

### CROSS-REFERENCE TO RELATED APPLICATION

This application claims priority under 35 U.S.C. §119(e) to U.S. Provisional Patent Application Ser. No. 60/750,484, filed Dec. 15, 2005, and the contents of which are hereby incorporated by reference.

### TECHNICAL FIELD

This invention relates to fuel cell gas diffusion articles containing a porous layer, as well as related components, systems, and methods.

### BACKGROUND

Fuel cells can be used to convert chemical energy to electrical energy by promoting a chemical reaction between, for example, hydrogen and oxygen.

FIG. 1 shows an embodiment of a fuel cell 100. Fuel cell 100 includes a solid electrolyte 110, a cathode catalyst 120, an anode catalyst 130, a cathode gas diffusion layer 140, an anode gas diffusion layer 150, a cathode flow field plate 160 having channels 162, and an anode flow field plate 170 having channels 172.

Solid electrolyte 110 can be formed of a solid polymer, such as a solid polymer ion exchange resin (e.g., a solid polymer proton exchange membrane). Examples of proton exchange membrane materials include partially sulfonated, fluorinated polyethylenes, which are commercially available as the NAFION® family of membranes (E.I. DuPont deNemours Company, Wilmington, Del.).

Cathode and anode catalysts 120 and 130 can be formed, for example, of platinum, a platinum alloy, or platinum dispersed on carbon black.

Cathode and anode flow field plates 160 and 170 can be formed of a solid, electrically conductive material, such as graphite.

Typically, fuel cell 100 operates as follows.

Hydrogen enters anode flow field plate 170 at an inlet region of anode flow field plate 170 and flows through channels 172 toward an outlet region of anode flow field plate 170. At the same time, oxygen (e.g., air containing oxygen) enters cathode flow field plate 160 at an inlet region of cathode flow field plate 160 and flows through channels 162 toward an outlet region of cathode flow field plate 160.

As the hydrogen flows through channels 172, the hydrogen passes through anode gas diffusion layer 150 and interacts with anode catalyst 130, and, as oxygen flows through channels 162, the oxygen passes through cathode gas diffusion layer 140 and interacts with cathode catalyst 120. Anode catalyst 130 interacts with the hydrogen to catalyze the conversion of the hydrogen into electrons and protons, and cathode catalyst 120 interacts with the oxygen, electrons and protons to form water. The water flows through gas diffusion layer 140 to channels 162, and then along channels 162 toward the outlet region of cathode flow field plate 160.

Solid electrolyte 110 provides a barrier to the flow of the electrons and gases from one side of electrolyte 110 to the other side of the electrolyte 110. But, electrolyte 110 allows the protons to flow from the anode side of membrane 110 to the cathode side of membrane 110. As a result, the protons can flow from the anode side of membrane 110 to the cathode side of membrane 110 without exiting fuel cell 100, whereas the electrons flow from the anode side of membrane 110 to the cathode side of membrane 110 via an electrical circuit that is external to fuel cell 100. The external electrical circuit is typically in electrical communication with anode flow field plate 170 and cathode flow field plate 160.

In general, the electrons flowing through the external electrical circuit are used as an energy source for a load within the external electrical circuit.

### SUMMARY

This invention relates to fuel cell gas diffusion articles containing a porous layer.

In one aspect, the invention features an article that includes a substrate having a surface and a porous layer supported by the surface of the substrate. The porous layer includes electrically conductive particles and a polymer and has a thickness of at most about 30 μm. The article is configured as a fuel cell gas diffusion article.

In another aspect, the invention features an article identical to the article described above except that the porous layer includes electrically conductive particles and a polysulfone.

In another aspect, the invention features an article identical to the article described above except that the porous layer includes electrically conductive particles, a polyvinylidene fluoride, and nanotubes.

In another aspect, the invention features a method that includes (1) applying a mixture onto a surface of a substrate to form a layer, in which the mixture includes electrically conductive particles and a polymer in a first solvent and the weight of the polymer is at most about 10% of the weight of the first solvent; and (2) removing the first solvent by contacting the layer with a second solvent miscible with the first solvent to form a fuel cell gas diffusion article, in which the second solvent is a non-solvent to the polymer.

In another aspect, the invention features a membrane electrode assembly that includes first and second gas diffusion articles, first and second catalyst layers between the first and second gas diffusion articles; and a solid electrolyte between the first and second catalyst layers. The first gas diffusion article includes a substrate having a surface and a porous layer supported by the surface of the substrate. The porous layer includes electrically conductive particles and a polymer and having a thickness of at most about 30 μm.

In still another aspect, the invention features a fuel cell that includes a membrane electrode assembly described above.

Embodiments can include one or more of the following features.

The layer can have a thickness of at least about 5 μm.

The polymer can include a polyvinylidene fluoride or a polysulfone.

The electrically conductive particles can include carbon particles. In some embodiments, the carbon particles can include graphite, amorphous carbon, active carbon, or carbon black.

The electrically conductive particles can also include a metal oxide. In some embodiments, the metal oxide includes an oxide of titanium, aluminum, manganese, molybdenum, nickel, or cobalt.

The weight ratio between the polymer and the electrically conductive particles is at least about 1:2 or at most about 2:1.

The layer can further include nanotubes. In some embodiments, the nanotubes can include carbon or an oxide of manganese, titanium, or tungsten. In certain embodiments, the weight of the nanotubes can be at least about 0.1% of the weight of the polymer.

The layer can include a plurality of pores uniformly distributed in substantially all directions throughout the layer. In some embodiments, the pores can have an average pore diameter of at least about 0.1 μm or at most about 30 μm. In certain embodiments, the pores can include open pores.

The layer can have an air permeability of at least about 0.5 cfm (i.e., Frazier number).

The layer can have a through-plane resistivity of at most about 4 ohm-cm.

The substrate can include an electrically conductive material (e.g., a carbonaceous material).

The first solvent can include N-methyl-2-pyrrolidone or dimethylformamide.

The second solvent can include water. In some embodiments, the second solvent can further include the first solvent.

The weight of the polymer can be at least about 3% or at most about 7% of the weight of the first solvent.

The mixture can have a viscosity of at least about 3,000 centipoise (e.g., at least about 200,000 centipoise).

The second gas diffusion article can include a substrate having a surface and a porous layer supported by the surface of the substrate. The porous layer can include electrically conductive particles and a polymer and having a thickness of at most about 30 μm.

Embodiments can provide one or more of the following advantages.

In some embodiments, a fuel cell gas diffusion article containing a polysulfone can have an operating temperature (up to 160° C.) higher than that containing a polyvinylidene fluoride.

In some embodiments, including nanotubes in a porous layer of a fuel cell gas diffusion article can improve deposition and adhesion of the polymer in the porous layer on the substrate supporting the layer, reduce permeating of the porous layer into the substrate, and offer flexibility in altering air permeability of the porous layer.

In some embodiments, the method described above can be performed continuously, thereby reducing the costs for producing membrane electrode assemblies and fuel cells.

In some embodiments, the method described above can be performed at an ambient temperature (e.g., from about 25° C. to about 50° C.), thereby avoiding the equipment and costs associated with a high temperature sintering process.

In some embodiments, the method described above can result in a crack-free porous layer whose pore size and density can be readily adjusted.

Other features and advantages of the invention will be apparent from the description, drawings and claims.

### DESCRIPTION OF DRAWINGS

FIG. 1 is a cross-sectional view of an embodiment of a fuel cell; and

FIG. 2 is a cross-sectional view of an embodiment of a fuel cell gas diffusion article.

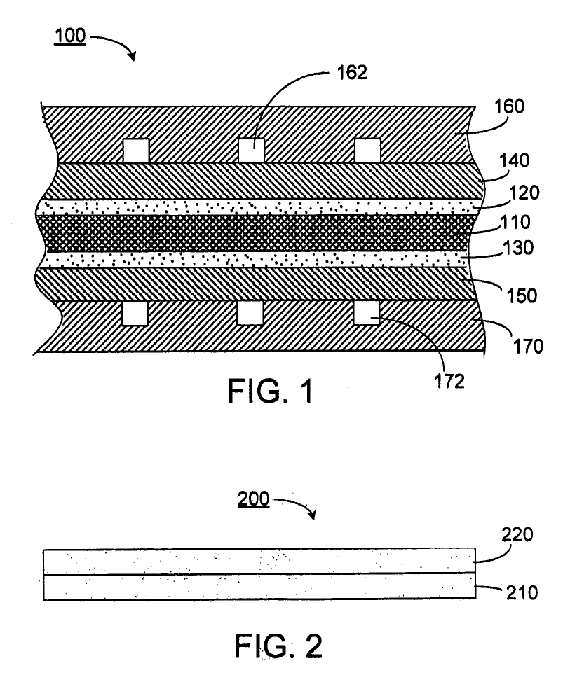

### DETAILED DESCRIPTION

FIG. 2 shows a fuel cell gas diffusion article 200 having a substrate 210 and a porous layer 220.

In general, porous layer 220 includes electrically conductive particles and a polymer. The electrically conductive particles can be formed of any suitable materials. Examples of electrically conductive particles include carbon particles and metal oxide particles. Examples of carbon particles include graphite, amorphous carbon, active carbon, and carbon black. A commercially available type of carbon particles is Cabot VULCAN XC72. Examples of metal oxide particles include oxides of titanium, aluminum, manganese, molybdenum, nickel, and cobalt. The amount of the electrically conductive particles can be adjusted to obtain a desired conductivity. Optionally, combinations of different types of electrically conductive particles can be used.

The polymer that can be used in porous layer 220 is typically soluble in a water-miscible organic solvent at room temperature. The polymer can be either a fluoropolymer (e.g., polyvinylidene fluoride) or a non-fluoropolymer (e.g., polysulfone). In some embodiments, the polymer can be a homopolymer (e.g., polyvinylidene fluoride or polysulfone). In certain embodiments, the polymer can be a copolymer. The number average molecular weight of the polymer can be at least about 30,000 Daltons (e.g., at least about 45,000 Daltons) or at most about 90,000 Daltons (e.g., at most about 60,000 Daltons). Without wishing to be bound by theory, it is believed that a gas diffusion article containing a polysulfone can have an operating temperature (up to 160° C.) higher than that containing a polyvinylidene fluoride.

In some embodiments, the weight ratio between the polymer and the electrically conductive particles (e.g., carbon particles) in porous layer 220 can be at most about 2:1 (e.g., at most about 4:3, at most about 3:2, or at most about 1:1) or at least about 1:2 (at least about 2:3, at least about 3:4, or at least about 1:1).

Porous layer 220 can further include nanotubes. Without wishing to be bound by theory, it is believed that including nanotubes in porous layer 220 can improve deposition and adhesion of the polymer on the surface of substrate 210, reducing permeating of layer 220 into substrate 210, and offer flexibility in altering air permeability of the gas diffusion article 200.

In some embodiments, the nanotubes can have an average diameter of at least about 5 nm (e.g., at least about 10 nm or at least about 15 nm) or at most about 25 nm (e.g., at most about 20 nm or at most about 15 nm). In some embodiments, the nanotubes can have an average length of at least about 5 nm (e.g., at least about 10 nm or at least about 20 nm). For example, the nanotubes can have an average diameter in the range of from about 10 to about 15 nm and an average length of about 10 nm. In some embodiments, the nanotubes can be curled in shape. In these embodiments, the length of the nanotubes refers to that of the nanotubes in an extended configuration.

In general, the nanotubes can be made from any suitable materials. Examples of such materials include carbon and metal oxide (e.g., manganese oxide, titanium oxide, or tungsten oxide). In some embodiments, the weight of the nanotubes can be at least about 0.1% (e.g., at least about 0.2%, at least about 0.5%, or at least about 1%) of the weight of the polymer.

In some embodiments, porous layer 220 can have a thickness at least about 5 μm (e.g., at least about 10 μm, at least about 15 μm, or at least about 20 μm) or at most about 30 μm (e.g., at most about 25 μm, at most about 20 μm, or at most about 15 μm). Without wishing to be bound by theory, it is believed that a thin porous layer (e.g., with a thickness of at most about 30 μm) can lead to the uniform distribution of the pores in substantially all directions throughout layer 220.

In general, layer 220 includes a plurality of pores (e.g., open pores). In some embodiments, substantially all of the pores are open pores. In some embodiments, the pores can have an average pore diameter of at most about 30 μm (e.g., at most about 20 μm, at most about 10 μm, or at most about 5 μm) or at least about 0.1 μm (e.g., at least about 0.5 μm, at least about 1 μm, or at least about 5 μm). In certain embodiments, the difference in the pore diameters varies less than about 10% (e.g., less than about 5% or less than about 1%). Layer 220 containing larger pores generally has a lower density and a higher gas permeability.

In some embodiments, the pores are uniformly distributed in substantially all directions throughout layer 220. In certain embodiments, the difference in the distances between the centers of two neighboring pores varies less than about 10% (e.g., less than about 5% or less than about 1%).

In some embodiments, porous layer 220 has an air permeability of at least about 0.5 cfm (e.g., at least about 1 cfm, at least about 5 cfm, at least about 10 cfm, at least about 40 cfm, or at least about 80 cfm).

In some embodiments, porous layer 220 has a through-plane resistivity of at most about 4 ohm-cm (e.g., at most about 3 ohm-cm, at most about 2 ohm-cm, or at most about 1 ohm-cm). The through-plane resistivity referred to herein is measured according to ASTM D 257.

In some embodiments, porous layer 220 has a in-plane resistivity of at most about 10 ohm/sq (e.g., at most about 8 ohm/sq, at most about 6 ohm/sq, at most about 4 ohm/sq, or at most about 2 ohm/sq). The in-plane resistivity referred to herein is measured according to ASTM D 257.

In general, substrate 210 can be formed of a carbonaceous material, such as, a wet laid or a dry laid conductive carbon web in roll format. In certain embodiments, substrate 210 can have a thickness of at least about 0.05 millimeter (e.g., at least about 0.1 millimeter) or at most about 2.5 millimeter (e.g., at most about 2.0 millimeter).

Gas diffusion article 200 can be used to prepare a membrane electrode assembly. For example, a membrane electrode assembly can include two gas diffusion articles 200 (one being incorporated in an anode and one being incorporated in an cathode), two catalyst layers disposed between the two gas diffusion articles 200, and a solid electrolyte between the two catalyst layers. Such a membrane electrode can be used in a fuel cell. Gas diffusion article 200 can be prepared as follows. A polymer (e.g., polyvinylidene or polysulfone) can first be dissolved in a first solvent (e.g., a water-miscible organic solvent, such as N-methyl-2-pyrrolidone or dimethylformamide) at room temperature. A conductive carbon powder (e.g., carbon black) can then be added to the solution thus prepared to form a mixture. The mixture can subsequently be coated onto a surface of substrate 210 (e.g., a conductive carbon web) by a conventional method (e.g., screen coating). After the mixture is uniformly applied on substrate 210, it is placed in contact with a second solvent (e.g., water or an aqueous solution) at a suitable operating temperature (e.g., from about 25° C. to about 50° C.). The second solvent is miscible with the first solvent but is a non-solvent to the polymer at the operating temperature. The term “non-solvent” used herein refers to a solvent that does not substantially dissolve the polymer at the operating temperature. As the first solvent is dissolved in the second solvent, the polymer and the carbon particles are separated from the first solvent. Porous layer 220 can be then be formed on substrate 210 after drying.

The viscosity of the mixture used in the above method can be adjusted by using different amounts of the first solvent or different weight ratios between the polymer and the carbon powder. In certain embodiments, the mixture has a viscosity of at least about 3,000 centipoise (e.g., at least about 6,000 centipoise, at least about 10,000 centipoise, at least about 100,000 centipoise, at least about 200,000 centipoise, or at least about 1,000,000 centipoise). Without wishing to be bound by theory, it is believed that the viscosity of the mixture should be kept in a certain range (e.g., from about 5,000 centipoise to about 100,000 centipoise) to form a porous layer with desirable properties. If the viscosity is too high, the mixture may not be coated uniformly on a substrate or may not form a layer containing uniformly distributed pores. If the viscosity is too low, the porous layer thus formed tends to permeate into the substrate (e.g., conductive carbon webs) and therefore impair the performance of the fuel cell.

In some embodiments, the weight of the polymer in the above-mentioned mixture is at most about 10% (e.g., at most about 7% or at most about 5%) or at least about 1% (e.g., at least about 3% or at least about 5%) of the weight of the first solvent. In general, using a smaller amount of the polymer lowers the viscosity of the mixture, thereby resulting in a thinner layer having larger pores. Further, without wishing to be bound by theory, it is believed that the performance of a fuel cell is optimized (e.g., having a higher cell voltage at a certain current density) when the weight of the polymer is less than a certain percentage (e.g., less than about 6%) of the weight of the first solvent.

In some embodiments, the second solvent can be an aqueous solution, such as a solution of water and the first solvent. In these embodiments, the weight of the first solvent can be at most about 10% (e.g., at most about 8%, at most about 6%, at most about 4%) of the weight of the second solvent. Without wishing to be bound by theory, it is believed that including the first solvent in the second solvent can slow down the extraction process of the first solvent from the coating mixture applied onto the substrate and therefore can be used to adjust the pore structures of the layer thus formed. Further, without wishing to be bound by theory, it is believed that the performance of a fuel cell is optimized (e.g., having a higher cell voltage at a certain current density) when the weight of the first solvent is less than a certain percentage (e.g., less than about 4%) of the weight of the second solvent.

Without wishing to be bound by theory, it is believed that the above-described method possesses at least the following three advantages: (1) This method can be performed continuously, thereby reducing the costs for producing membrane electrode assemblies and fuel cells. (2) This method can be performed at an ambient temperature (e.g., from about 25° C. to about 50° C.), thereby avoiding the equipment and costs associated with the high temperature sintering process. (3) This method can result in a crack-free porous layer whose pore size and density can be readily adjusted.

The following examples are illustrative and not intended to be limiting.

### EXAMPLE 1

Conductive carbon webs were soaked in a 0.1 wt % solution of REPEARL 35 (Mitsubishi Chemical Company, Tokyo, Japan) for 2 hours and then dried for use as a substrate in the following process.

A coating solution was prepared by dissolving 5.34 g of polyvinylidene fluoride (PVDF) (Solef 6020 resin; Solvay Solexis, Houston, Tex.) in 109.6 g of a coating solvent N-methyl-2-pyrrolidone (NMP). After 10.44 g of carbon black (Cabot VULCAN XC72, Cabot Corporation, Billerica, Mass.) was added to the above solution, the mixture was blended thoroughly. The mixture was then degassed under vacuum at room temperature for 2 hours and was applied on a conductive carbon web through a 12XX screen on a SPEED-BALL silk screen kit. The coated carbon web was then soaked in water over night to dissolve N-methyl-2-pyrrolidone and then dried to form a uniform porous layer on the web. The porous layer was about 0.3 to 0.4 g over a 5″×5″ area and has a density of about 18 g/m² to 25 g/m². The same process was repeated by using an extraction solvent containing different percentage of the coating solvent, different PVDF/solvent weight ratios, different PVDF/carbon weight ratios, and at different extraction temperatures. These process conditions are summarized in Table 1 below.

TABLE 1

| | | Percentage of | | PVDF/ |
|---|---|---|---|---|
| | Water Temperature | coating solvent | PVDF/solvent | carbon |
| | (° C.) | in water (%) | weight ratio | weight ratio |
| 1 | 25 | 0 | 0.05 | 0.5 |
| 2 | 40 | 0 | 0.05 | 0.75 |
| 3 | 25 | 10 | 0.05 | 0.75 |
| 4 | 40 | 10 | 0.05 | 0.5 |
| 5 | 25 | 0 | 0.067 | 0.75 |
| 6 | 40 | 0 | 0.067 | 0.5 |
| 7 | 25 | 10 | 0.067 | 0.5 |
| 8 | 40 | 10 | 0.067 | 0.75 |

Scanning electron microscope (SEM) was used to study the coatings prepared above. The cross sectional views of the SEM pictures showed that uniform coatings that do not permeate into the conductive carbon webs could be obtained when the viscosity of the coating mixture is kept sufficiently high (>200,000 centipoise).

The performance of the coatings prepared above was evaluated in a fuel cell (25 cm² fixture, Fuel Cell Technologies, Albuquerque, N. Mex.) on a MEDUSA fuel cell test stand (Teledyne Energy Systems, Inc., Hunt Valley, Md.) controlled by a Scribner 890C electronic load at 65° C. under a 100% relative humidity using either air or oxygen as an oxidant. The viscosities of the coating mixture, the physical properties of the porous layer and the voltages of the fuel cells containing the coatings prepared above are summarized in Table 2.

TABLE 2

| | | Mean | | | | FC | FC | |
|---|---|---|---|---|---|---|---|---|
| | | Flow | Permeability | Through- | | voltage | voltage | Stack |
| | Viscosity | Pore | (Ft³/ | plane R | In-plane R | (V) at | (V) at | R at |
| | (centipoise) | (microns) | min) | (ohm-cm) | (ohm/sq) | 1,400 mA/cm² | 1,000 mA/cm² | 1,000 ohm |
| 1 | 228,000 | 32.8 | 8.61 | 1.6789 | 2.4 | 0.572 | 0.618 | 3.96 |
| 2 | 970,000 | 17 | 10.54 | 1.1637 | 4.33 | 0.583 | 0.6338 | 2.278 |
| 3 | 820,000 | 5.23 | 13.61 | 1.3169 | 7.4 | 0.572 | 0.622 | 2.608 |
| 4 | 120,000 | 15.7 | 14.07 | 2.0195 | 7.86 | 0.544 | 0.5959 | 2.661 |
| 5 | 960,000 | 10.6 | 3.28 | 1.6193 | 4.7 | 0.544 | 0.5997 | 3.7 |
| 6 | >1,000,000 | 36.6 | 4.18 | 1.9354 | 4.98 | 0.5947 | 0.626 | 3.04 |
| 7 | >1,000,000 | 25.78 | 3.19 | 0.8303 | 4.54 | 0.54 | 0.526 | 3.87 |
| 8 | 187,000 | 39.83 | 1.2 | 0.9301 | 3.1 | 0.526 | 0.56 | 3.617 |

The polarization curves were plotted for the fuel cells containing the coatings prepared above and a fuel cell containing polytetrafluoroethylene (PTFE). The results showed that the performance of all of the fuel cells containing the coatings prepared above surpassed that of the fuel cell containing PTFE.

### EXAMPLE 2

Four coating compositions were prepared: (1) a PVDF composition without nanotubes (Solef 6020 resin; Solvay Solexis, Houston, Tex.), (2) a polysolfone composition (UDEL P-3500 resin; Solvay Solexis, Houston, Tex.), and (3) and (4) two PVDF compositions with carbon nanotubes (HC325, Hyperion Catalysis, Cambridge, Mass.). When the weight of the carbon nanotubes in compositions (3) and (4) was 0.2% of the weight of PVDF. PVDF or polysulfone was first dissolved in NMP under continuous stirring to form a solution. After the polymer was completely dissolved, carbon powder was added into the solution gradually as the viscosity of the solution increased. After the mixture was allowed to settle, it was reblended with a high shear mixer to ensure a uniform dispersion.

Each of the coating compositions prepared above was then applied to a carbon web substrate that was treated with micronized PTFE (Whitford 505050, Whitford Corporationn, West Chester, Pa.). The substrate was secured to a highly flat but compressible coating surface (½″ thick glass sheet covered with 0.063″ thick 100 Shore A EPDM rubber) with low tack adhesive tape. The coating composition was deposited on the edge of the low tack adhesive tape. A coating rod was placed at the edge of the deposition and drawn forward at a speed of about one meter per minute. A #12 meyer coating rod was used for coating compositions (1) and (4), and a #6 meyer coating rod was used for coating compositions (2) and (3). The coated substrate was then immersed with the coated side down in an extraction bath containing water at 45° C. The coated substrates were subsequently soaked at room temperature (25° C.) for 2 hours to remove residue NMP and then dried on a large semicircular dryer at 110° C.

The components of the coating compositions and their physical properties are summarized in Table 3 below.

TABLE 3

| | | | | Deposit | Air | |
|---|---|---|---|---|---|---|
| Polymer | Viscosity | Carbon | Polymer | weight | permeability | Through plane R |
| name | (K Cp) | (wt %) | (wt %) | (g/m²) | (cfm) | (ohm-cm) |
| PVDF | 28 | 2.2 | 4.4 | 3.8 | 2.5 | 2 |
| Polysulfone | 12 | 5.8 | 3 | 4.2 | 1.5 | 2.8 |
| PVDF + nanotubes | 6 | 3 | 4.8 | 4.1 | 4.5 | 2.8 |
| PVDF + nanotubes | 6 | 3 | 4.8 | 13.1 | 5.5 | 2.6 |

The coated substrates were placed in a 3-layer membrane electrode assembly (5510 MEA, W. L. Gore & Associates, Elkton, Md.) and tested in a fuel cell (25 cm² fixture, Fuel Cell Technologies, Albuquerque, N. Mex.) with a single serpentine flow pattern. The tests were performed on a MEDUSA fuel cell test stand (Teledyne Energy Systems, Inc., Hunt Valley, Md.) controlled by a Scribner 890C electronic load at 65° C. under a 100% relative humidity or at 85° C. under 50% humidity. The results showed that the fuel cells containing polysulfone coating (2) and PVDF coating (3) and (4) exhibited comparable cell voltages with the fuel cell containing PVDF (1) at the same current density.

Other embodiments are in the claims.

What is claimed is:

1. An article, comprising:
a substrate having a surface; and
a porous layer supported by the surface of the substrate; the porous layer comprising electrically conductive particles and a polymer, and having a thickness of at most about 30 μm;
wherein the article is configured as a fuel cell gas diffusion article.

2. The article of claim 1, wherein the layer has a thickness of at least about 5 μm.

3. The article of claim 1, wherein the polymer comprises a polyvinylidene fluoride or a polysulfone.

4. The article of claim 1, wherein the electrically conductive particles comprise carbon particles.

5. The article of claim 4, wherein the carbon particles comprise graphite, amorphous carbon, active carbon, or carbon black.

6. The article of claim 1, wherein the electrically conductive particles comprise a metal oxide.

7. The article of claim 1, wherein the metal oxide comprises an oxide of titanium, aluminum, manganese, molybdenum, nickel, or cobalt.

8. The article of claim 1, wherein the weight ratio between the polymer and the electrically conductive particles is at most about 2:1.

9. The article of claim 1, wherein the weight ratio between the polymer and the electrically conductive particles is at least about 1:2.

10. The article of claim 1, wherein the layer further comprises nanotubes.

11. The article of claim 10, wherein the nanotubes comprises carbon or an oxide of manganese, titanium, or tungsten.

12. The article of claim 10, wherein the weight of the nanotubes is at least about 0.1% of the weight of the polymer.

13. The article of claim 1, wherein the layer comprises a plurality of pores uniformly distributed in substantially all directions throughout the layer.

14. The article of claim 13, wherein the pores have an average pore diameter of at most about 30 μm.

15. The article of claim 13, wherein the pores have an average pore diameter of at least about 0.1 μm.

16. The article of claim 13, wherein the pores comprises open pores.

17. The article of claim 1, wherein the layer has an air permeability of at least about 0.5 cfm.

18. The article of claim 1, wherein the layer has a through-plane resistivity of at most about 4 ohm-cm.

19. The article of claim 1, wherein the substrate comprises an electrically conductive material.

20. An article, comprising:
a substrate having a surface; and
a porous layer supported by the surface of the substrate; the porous layer comprising electrically conductive particles and a polysulfone;
wherein the article is configured as a fuel cell gas diffusion article.

21. An article, comprising:
a substrate having a surface; and
a porous layer supported by the surface of the substrate; the porous layer comprising electrically conductive particles, a polyvinylidene fluoride, and nanotubes;
wherein the article is configured as a fuel cell gas diffusion article.

22. A method, comprising:
applying a mixture onto a surface of a substrate to form a layer, wherein the mixture comprises electrically conductive particles and a polymer in a first solvent and the weight of the polymer is at most about 10% of the weight of the first solvent; and
removing the first solvent by contacting the layer with a second solvent miscible with the first solvent to form a fuel cell gas diffusion article, wherein the second solvent is a non-solvent to the polymer.

23. The method of claim 22, wherein the first solvent comprises N-methyl-2-pyrrolidone or dimethylformamide.

24. The method of claim 22, wherein the second solvent comprises water.

25. The method of claim 24, wherein the second solvent further comprises the first solvent.

26. The method of claim 22, wherein the weight of the polymer is at most about 7% of the weight of the first solvent.

27. The method of claim 22, wherein the weight of the polymer is at least about 3% of the weight of the first solvent.

28. The method of claim 22, wherein the mixture has a viscosity of at least about 3,000 centipoise.

29. The method of claim 22, wherein the mixture has a viscosity of at least about 200,000 centipoise.

30. A membrane electrode assembly, comprising:
a first gas diffusion article, the first gas diffusion article comprising:
a substrate having a surface; and
a porous layer supported by the surface of the substrate; the porous layer comprising electrically conductive particles and a polymer, and having a thickness of at most about 30 μm;
a second gas diffusion article;
first and second catalyst layers between the first and second gas diffusion articles; and
a solid electrolyte between the first and second catalyst layers.

31. The membrane electrode assembly of claim 30, wherein the second gas diffusion article comprises:
a substrate having a surface; and
a porous layer supported by the surface of the substrate; the porous layer comprising electrically conductive particles and a polymer, and having a thickness of at most about 30 μm.

32. A fuel cell comprising a membrane electrode assembly of claim 30.

33. The fuel cell of claim 32, wherein the second gas diffusion article comprises:
a substrate having a surface; and
a porous layer supported by the surface of the substrate; the porous layer comprising electrically conductive particles and a polymer, and having a thickness of at most about 30 μm.
